(19) United States
(12) Patent Application Publication
(10) Pub. No.: US 2011/0056994 A1
(43) Pub. Date: Mar. 10, 2011

(54) Glue Gun

(76) Inventor: Shui Di Yen, Guangdong (CN)

(21) Appl. No.: 12/513,360

(22) PCT Filed: Dec. 3, 2007
(86) PCT No.: PCT/CN07/03434

§ 371 Date: May 2, 2009

(30) Foreign Application Priority Data
Oct. 31, 2007 (CN) 200720059014.6

(51) Int. Cl. B05C 17/01

(52) U.S. Cl. 222/326; 222/391

(57) ABSTRACT

A caulk gun comprises a feeding device and a container where a glue cylinder is provided. The feeding device includes a main body (1) that is provided with a first hollow part and a second hollow part that are separated by a partition board (11), the main body (1) also includes a handle (10) that is formed by the lower of the second hollow part extending downwards, the first hollow part being provided with a deflector rod (14), one side of the deflector rod being close to the partition board (11), a deflector board spring (12) being set between the other side of the deflector rod and the main body; a pushing rod (2) that passes through the main body (1) and the first hollow part and the second hollow part, the deflector board spring (12) and the deflector rod (14) encircling the pushing rod (2); a trigger (3) that is connected to the handle (10) by a pivot pin (26), moves back and forth around the pivot pin (26) relative to the handle (10) and pushes the deflector rod (14). The second hollow part is provided with a resetting loop (13) that encircles the pushing rod (2) and away from the partition board (11) a suitable clearance. The caulk gun has a simple structure and simple operation.

### FIELD OF THE INVENTION

The present invention involves a surface ejector device, especially involves a glue gun.

### BACKGROUND OF THE INVENTION

A conventional handheld glue gun, such as a glue gun that is formed by the glue gun feeding device disclosed in the Chinese patent No. 00257653.8 being combined with a structure capable of containing the cartridge, comprises a main body; the main body forms two paratactic hollowed-out parts, the first hollowed-out part and the second hollowed-out part; the two hollowed-out parts are separately provided with a deflector rod and a brake rod; one spring is located between the deflector rod and the main body, and another spring is located between the brake rod and the main body; a movable rod connecting the deflector rod and the brake rod is located between the two hollowed-out parts, the structure of which is set as that its length can just fit a bolt to make the deflector rod be perpendicular to a push rod when the movable rod is pressed against the brake rod.

However, the glue gun feeding device of the above mentioned structure requires the dimension and shape of the components to be very precise, so as to get comparatively good effect of glue dispensing.

Moreover, Chinese patent No. 03240344.5 also disclosed a feeding device of a glue gun, which comprises a first section and a second section; the first section is provided with a coupling and a drive sheet, and the second section is provided with a linkage plate; a movable lever is connected to the coupling via the linkage plate, so as to control the rotating of the coupling in the first section to push a push rod. However, the structure of the feeding device is very complicated, so it will bring great inconvenience to the production and manufacture.

### SUMMARY OF THE INVENTION

According to the above mentioned disadvantages of the conventional art, the present invention provides a glue gun with simple structure and good effect.

To solve the above mentioned technical problems, the present invention provides the following technical solution that:

a glue gun includes a feeding device and a container containing the cartridge, wherein the feeding device comprises:

a main body, the main body being provided with two paratactic, a first and a second, hollowed-out parts, the two hollowed-out parts being separated by a clapboard, the main body also including a handle, the handle extending downward from the lower end of the second hollowed-out part, the first hollowed-out part being provided with a deflector rod, one side of the defector rod being near the clapboard, and a deflector spring being located between the other side of the defector rod and the main body;

a push rod, the push rod being through the main body and the two hollowed-out parts, the deflector spring and the deflector rod being fixed to the push rod by socket joint;

a lever, the lever being connected to the handle of the main body via a shaft, which implements front and back reciprocating motion relative to the handle around the shaft to push the deflector rod to drive the push rod to move forward;

the second hollowed-out part being provided with a reset ring, the reset ring being fixed to the push rod by socket joint, and a suitable clearance being provided between the reset ring and the clapboard, which is used as a drawing back space for the reset ring to cut the glue.

Preferably, the end adjacent to the clapboard of the reset ring is caverned out at the middle part, and the end adjacent to the main body is provided with a symmetrical opening.

Preferably, a bracing sheet is provided at the position where the lever pushes the deflector rod to move to enhance the strength of the lever, so as to improve the precision of the distance that the push rod moving forward for, and to extend the service life of the lever.

Preferably, a cover board is located at the upward side of the main body, and the cover board is connected to the main body by snap-fit joint.

Preferably, the periphery of the main body extends forward to form the container for containing the cartridge, and the main body is forward in turn provided with a disc spring, a disc, a claw shaped elastic sheet, and a locating guide sleeve; one end of the claw shaped elastic sheet is fixed to the locating guide sleeve, and the other end presses against the main body to compress the disc spring to be shrunk slightly; a baffle plate is also located between the deflector spring and the main body.

Preferably, the reset ring is made of rubber.

Preferably, an ejector block is also fixed at the front end of the push rod.

Preferably, a pull handle is also fixed at the back end of the push rod.

The advantages of the present invention are that:

1. in the present invention, the second hollowed-out part is provided with a reset ring being fixed to the push rod by socket joint, and a suitable clearance is provided between the reset ring and the clapboard; when the lever drives the push rod to move forward, for a bending deformation is produced at the hollow body at the front part of the reset ring, after the force to move forward is eliminated, the speed of the spring moving backward is increased, so as to make the pressure in the cartridge to be quickly released, which works well to cut the glue, and at the same time prevents the push rod from drawing back too much;

2. the present invention adopts the reset ring fixed to the push rod by socket joint to replace the conventional brake rod, so the structure is simple.

3. in the present invention, the periphery of the main body extends forward to form the container for containing the cartridge, and the main body is forward in turn provided with a disc spring, a disc, a claw shaped elastic sheet, and a locating guide sleeve; so, a glue gun of this structure can contain a cartridge of different length; when changing the cartridge, the ejector block is used to push the claw shaped elastic sheet backward to shrink the claw shaped elastic sheet; with the action of the disc spring, the cartridge is gently pushed out of the cartridge container, so, on assembling or disassembling the cartridge, the work efficiency is greatly increased.

### BRIEF DESCRIPTION OF THE DRAWINGS

FIG. 1 is an overall sectional view of an embodiment of the present invention;

FIG. 2 and FIG. 3 are stereograms of a preferred structure of the reset ring of the present invention.

### DESCRIPTION OF THE PREFERRED EMBODIMENT

The present invention is best understood from the following detailed description with reference to the accompanying figures and embodiments.

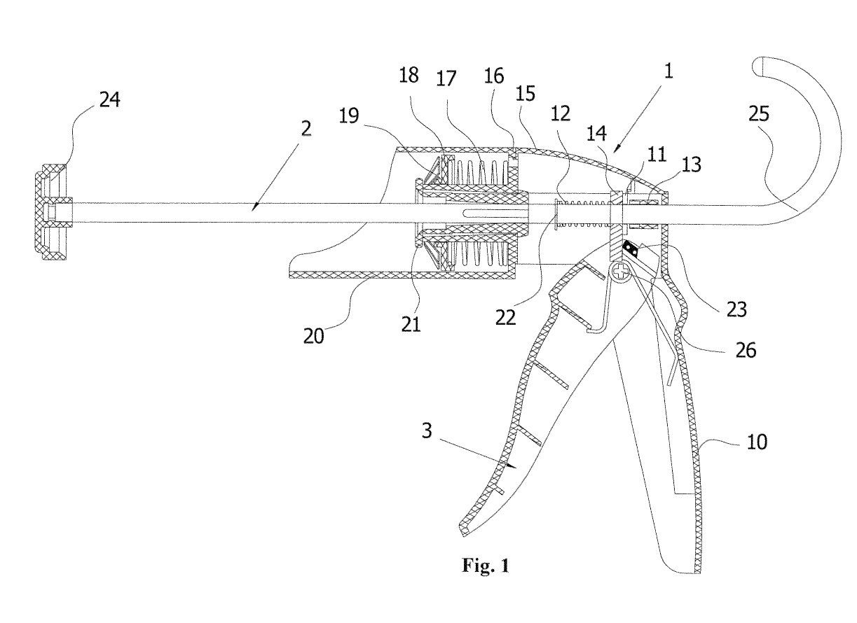

Referring to FIG. 1, the present invention mainly comprises a feeding device and a container containing the cartridge, and the feeding device comprises:

a main body 1, the main body being provided with two paratactic, a first and a second, hollowed-out parts, the two hollowed-out parts being separated by two clapboards 11, 22, the main body also including a handle 10, the handle 10 extending downward from the lower end of the second hollowed-out part, the first hollowed-out part being provided with a deflector rod 14, one side of the defector rod being near the clapboard 11, and a deflector spring 12 being located between the other side of the defector rod and the main body;

a push rod 2, the push rod being through the main body 1 and the two hollowed-out parts, the deflector spring 12 and the deflector rod 14 being fixed to the push rod 2 by socket joint;

a lever 3, the lever being connected to the main body handle 10 via a shaft 26, which implements front and back reciprocating motion relative to the handle 10 around the shaft 26 to push the deflector rod 14 to drive the push rod 2 to move forward;

the second hollowed-out part being provided with a reset ring 13, the reset ring 13 being fixed to the push rod 2 by socket joint, a suitable clearance being provided between the reset ring 13 and the clapboard 11 to make the reset ring 13 have some space to move at the second hollowed-out part, so as to stop the push rod 2 continuing to draw back as soon as the push rod 2 draws back a little, and to release the pressure in the cartridge, which works well to cut the glue, and at the same time prevents the push rod 2 from drawing back too much;

for the position where the lever 3 pushes the deflector rod 14 to move is easy to be damaged because of frequent friction, a bracing sheet 23 being provided at the position to enhance the strength of the lever, so as to improve the precision of the distance that the push rod moving forward for, and to extend the service life of the lever.

As a preferred embodiment of the present invention, a cover board 15 is located at the upward side of the main body 1; the cover board 15 is connected to the main body 1 by snap-fit joint, so as to make the components in the hollowed-out parts to be capable of being disassembled.

As a preferred embodiment of the present invention, the periphery of the main body 1 extends forward to form the container 20 for containing the cartridge, and the main body wall 16 is forward in turn provided with a disc spring 17, a disc 18, a claw shaped elastic sheet 19, and a locating guide sleeve 21; one end of the claw shaped elastic sheet 19 is fixed to the locating guide sleeve 21, and the other end presses against the main body 1 to compress the disc spring 17 to be shrunk slightly. The glue gun of this structure can contain a cartridge of different length; when changing the cartridge, an ejector block is used to push the claw shaped elastic sheet 19 backward to shrink the claw shaped elastic sheet 19; with the action of the disc spring 17, the disc 18 is pushed, and the disc 18 is forced to push the cartridge gently out of the claw shaped elastic sheet 19, so the operation is very simple and convenient. A baffle plate 22 is also located between the deflector spring 12 and the main body 1 to prevent the deflector spring 12 from moving the guide sleeve 21, so as not to affect the stability of the cartridge container fixing the cartridge.

As a preferred embodiment of the present invention, the reset ring 13 is made of rubber.

As a preferred embodiment of the present invention, an ejector block 24 is fixed at the front end of the push rod 2.

As a preferred embodiment of the present invention, the back end of the push rod 2 is also provided with a hook handle or a pull handle 25 fixed via a screw.

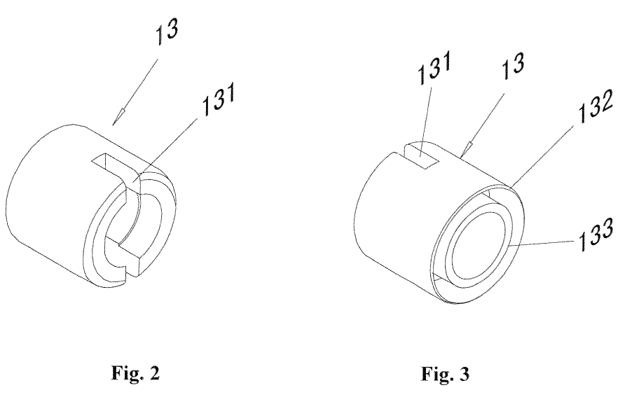

Referring to FIG. 2 and FIG. 3, they are stereograms of a preferred structure of the reset ring of the present invention. The reset ring 13 adopts elastic materials; the end adjacent to the clapboard of the reset ring 13 is caverned out at the middle part to form a barrel-shaped structure 132, and the other end is provided with a symmetrical opening 131; bending deformation is produced at the front part 133 of the reset ring 13; after the force to move forward is eliminated, the speed of the spring moving backward is increased, so as to make the pressure in the cartridge to be quickly released, which works well to cut the glue, and at the same time prevents the push rod from drawing back too much; for the front part is hollow, the reset ring 13 can abut against the push rod, so it is not easy to skid even after being used for multiple times; it has a long service life, and is easy for the push rod to be drawn backward, so the operation is easier.

Although the present invention has been described in detail with above said preferred embodiments, but it is only to make the people skilled in the art to understand the present invention, not to limit the scope of the present invention. For those skilled in the art, all the modifications and changes according to the characteristic and spirit of the present invention, are involved in the protected scope of the present invention. So, the protected scope of the present invention should be limited by the attached claims.

What is claimed is:

1. A glue gun including a feeding device and a container containing the cartridge, and the feeding device comprising:
a main body, the main body being provided with two paratactic, a first and a second, hollowed-out parts, the two hollowed-out parts being separated by a clapboard, the main body also including a handle, the handle extending downward from the lower end of the second hollowed-out part, the first hollowed-out part being provided with a deflector rod, one side of the defector rod being near the clapboard, and a deflector spring being located between the other side of the defector rod and the main body;
a push rod, the push rod being through the main body and the two hollowed-out parts, the deflector spring and the deflector rod being fixed to the push rod by socket joint; and
a lever, the lever being connected to the handle of the main body via a shaft, which implements front and back reciprocating motion relative to the handle around the shaft to push the deflector rod to drive the push rod to move forward;
characterized in that the second hollowed-out part is provided with a reset ring, and the reset ring is fixed to the push rod by socket joint with a suitable clearance being provided between the reset ring and the clapboard.

2. The glue gun of claim 1, wherein the reset ring is made of rubber.

3. The glue gun of claim 1, wherein an ejector block is also fixed at the front end of the push rod.

4. The glue gun of claim 1, wherein the back end of the push rod is provided with a hook handle or a pull handle fixed via a screw.

5. The glue gun of claim 1, wherein the end adjacent to the clapboard of the reset ring is caverned out at the middle part, and the end adjacent to the main body is provided with a symmetrical opening.

6. The glue gun of claim 5, wherein the reset ring is made of rubber.

7. The glue gun of claim 5, wherein an ejector block is also fixed at the front end of the push rod.

8. The glue gun of claim 5, wherein the back end of the push rod is provided with a hook handle or a pull handle fixed via a screw.

9. The glue gun of claim 1, wherein a bracing sheet is provided at the position where the lever pushes the deflector rod to move.

10. The glue gun of claim 9, wherein the reset ring is made of rubber.

11. The glue gun of claim 9, wherein an ejector block is also fixed at the front end of the push rod.

12. The glue gun of claim 9, wherein the back end of the push rod is provided with a hook handle or a pull handle fixed via a screw.

13. The glue gun of claim 1, wherein a cover board is located at the upward side of the main body, and the cover board is connected to the main body by snap-fit joint.

14. The glue gun of claim 13, wherein the reset ring is made of rubber.

15. The glue gun of claim 13, wherein an ejector block is also fixed at the front end of the push rod.

16. The glue gun of claim 13, wherein the back end of the push rod is provided with a hook handle or a pull handle fixed via a screw.

17. The glue gun of claim 1, wherein the periphery of the main body extends forward to form the container for containing the cartridge, and the main body is forward in turn provided with a disc spring, a disc, a claw shaped elastic sheet, and a locating guide sleeve; one end of the claw shaped elastic sheet is fixed to the locating guide sleeve, and the other end presses against the main body to compress the disc spring to be shrunk slightly; a baffle plate is also located between the deflector spring and the main body.

18. The glue gun of claim 17, wherein the reset ring is made of rubber.

19. The glue gun of claim 17, wherein an ejector block is also fixed at the front end of the push rod.

20. The glue gun of claim 17, wherein the back end of the push rod is provided with a hook handle or a pull handle fixed via a screw.
